(19) United States
(12) Patent Application Publication
(10) Pub. No.: US 2016/0004006 A1
(43) Pub. Date: Jan. 7, 2016

(54) BACKLIGHT SOURCE AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Kunpeng ZHU, Beijing (CN); Woong KIM, Beijing (CN); Hui ZHENG, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 14/429,933

(22) PCT Filed: Jun. 30, 2014
(86) PCT No.: PCT/CN2014/081236

§ 371 Date: Mar. 20, 2015

(30) Foreign Application Priority Data
Jan. 21, 2014 (CN) 201410027288.1

(51) Int. Cl. F21V 8/00

(52) U.S. Cl. CPC G02B 6/0078; G02B 6/0085; G02B 6/0068; G02B 6/009

(57) ABSTRACT

A backlight source comprises a back plate (1), a light source (2) and at least two light guiding plates (3), wherein the at least two light guiding plates are spaced from each other and disposed in the same layer over the back plate (1), the light source (2) is disposed in a spacing region (4) formed between two adjacent light guiding plates (3), and a light emitting surface (21) of the light source (2) is opposite to a first side of the light guiding plate (3) facing the spacing region (4). The backlight source enables the luminance of a whole big-size light guiding plate to be more uniform and the luminance of the optically distant end of the plate to reach a level required for display. Moreover, with respect to a direct illustrating type of backlight source, the backlight source is lighter and thinner, and has lower power consumption. The present disclosure further provides a display device.

### TECHNICAL FIELD

Embodiments of the present invention relates to a backlight source and a display device.

### BACKGROUND

A display device mainly consists of a display panel and a backlight source. Common backlight sources are classified into two types, i.e. direct illuminating and side illuminating, based on their relative positions relationship with respect to the display panel.

FIG. 1 illustrates a direct illuminating backlight source, wherein light sources 2 are disposed on a back plate 1, and a diffusing plate 7 is disposed over the light sources 2 to diffuse and mix the light emitted from them, so that the light can be mixed uniformly before being incident onto the display panel. In order to make the light incident onto the display panel from the light sources 2 fully mixed and more uniform, the diffusing plate 7 and the back plate I are usually spaced by a light mixing distance. The light mixing distance renders the thickness of the backlight source very great, hindering the display device from being thinner. Moreover, the direct illuminating backlight source consumes more power because it uses a great amount of light sources.

For a large-size display device (larger than 60 inches), the light mixing distance between the diffusing plate 7 and the back plate 1 increases correspondingly with the increase of the size of the display panel, which can be more adverse to thinning of the display device; and meanwhile, the amount of the light sources increases and the display device consumes more power as well.

### SUMMARY

To resolve the above-mentioned technical problems, at least one embodiment of the present disclosure provides a technical solution as follows. A backlight source enables luminance of the optically distant end of a large-sized light guiding plate to reach the level required for display as well and thus the luminance of the whole light guiding plate to be more uniform, so that the display luminance of a large-sized display panel can be more uniform.

A backlight source comprises a back plate, a light source and at least two light guiding plates, wherein the at least two light guiding plates are disposed in the same layer above the back plate and spaced from each other, the light source is disposed in a spacing region formed between two adjacent ones of the at least two light guiding plates, and the light emitting surface of the light source is opposite to the first side of the light guiding plate facing the spacing region.

In one embodiment according to the present disclosure, the light guiding plate is disposed parallel to the back plate and the first side of the light guiding plate forms an angle with respect to the base surface of the light guiding plate; the light emitting surface of the light source is parallel to the central line of the spacing region, faces the first side, and forms an angle with respect to the back plate that is greater than the angle formed between the first side and the back plate, and a height of the light source in the direction perpendicular to the back plate is less than a thickness of the light guiding plate.

In one embodiment according to the present disclosure, the at least two light guiding plates have the same shape and size, and two adjacent ones of the at least two light guiding plate are disposed symmetrically with the central line of the spacing region therebetween as the symmetry axis; the light emitting surface of the light source is parallel to the central line of the spacing region.

In one embodiment according to the present disclosure, the backlight source comprises a plurality of light sources arranged continuously in the direction of the central line of the spacing region.

In one embodiment according to the present disclosure, the light emitting surface of the light source is capable of emitting light rays within a range of 60°-120° with respect to the surface.

In one embodiment according to the present disclosure, an angle between the first side and the bottom surface of the light guiding plate is within a range of 30°-60°.

In one embodiment according to the present disclosure, the backlight source further comprises a heat sinking plate, which is disposed on the back plate along the central line of the spacing region and has its two opposite sides facing the light guiding plates provided with the light source.

In one embodiment according to the present disclosure, a height of the heat sinking plate in a direction perpendicular to the back plate is less than or equal to a thickness of the light guiding plate.

In one embodiment according to the present disclosure, the heat sinking plate is made of a good heat conductor and fixed on the back plate.

In one embodiment according to the present disclosure, the heat sinking plate is fixed on the back plate by means of screws or pins.

In one embodiment according to the present disclosure, the bottom surface of the light guiding plate has mesh points disposed thereon, which enable the light incident thereon to be reflected toward the top surface of the light guiding plate away from the back plate and then emitted uniformly through the top surface of the light guiding plate.

In one embodiment according to the present disclosure, the backlight source further comprises a reflection sheet, which is disposed between the back plate and the light guiding plate and extends into a region under the light source.

In one embodiment according to the present disclosure, the backlight source further comprises a prism sheet and a diffusing sheet which are disposed over the light guiding plate, with the prism sheet configured to collect axial light and the diffusing sheet configured to diffuse light.

At least one embodiment of the present disclosure further provides a display device comprising the above-mentioned backlight source.

In the backlight source according to the embodiments of the present disclosure, there exist at least two light guiding plates, among which there is a spacing region between any two adjacent ones in which a light source is disposed, so that the display luminance of the large-size display panel can be more uniform and the luminance of the optically distant end of the large-sized light guiding plate can reach the level required for display. And moreover, the backlight sources according to the embodiments of the present disclosure are all side illustrating backlight sources, which, compared with the direct illuminating ones, have an overall thickness that is greatly reduced, are lighter and thinner, and have a much lower quantity of light sources, so that the power consumption of the backlight source is greatly reduced.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a sectional view of a backlight source of direct illuminating type;

FIG. 2 is a sectional view of a backlight source according to embodiment one of the present disclosure;

FIG. 3 is a sectional view of a backlight source according to embodiment one of the present disclosure;

FIG. 4 is a top view of the backlight source as illustrated in FIG. 2;

FIG. 5 is a top view of a backlight source according to embodiment two of the present disclosure; and

FIG. 6 is a top view of another backlight source according to embodiment two of the present disclosure.

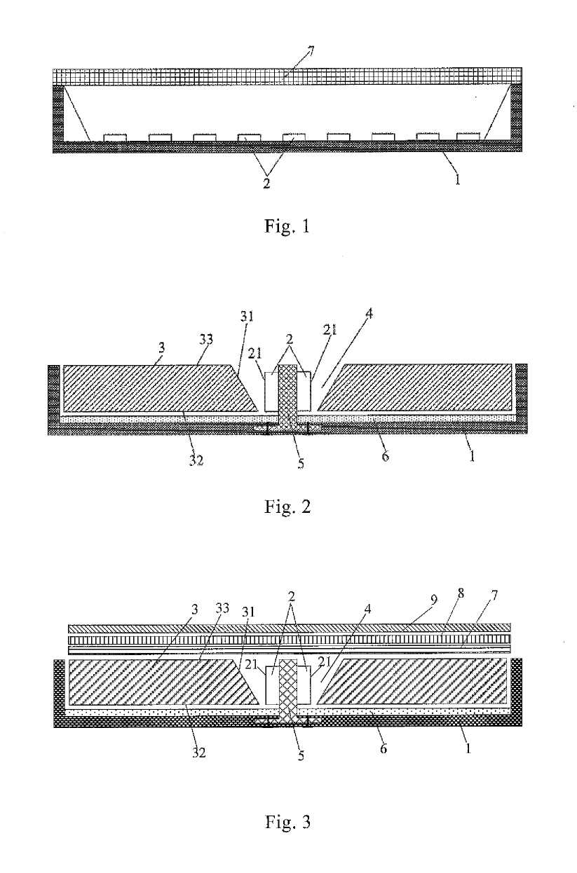

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

### Embodiment One

The present embodiment provides a backlight source which, as illustrated in FIG. 2, comprises a back plate 1, a light source 2 and at least two light guiding plates 3. The at least two light guiding plates are disposed in the same layer over the back plate 1 and spaced from one another, resulting in a spacing region 4 between two adjacent light guiding plates 3 in which the light source 2 is disposed. The light emitting surface 21 of the light source 2 is opposite to the first side 31 of the light guiding plate 3 facing to the spacing region 4. The light emitting surface 21 of the light source 2 refers to a surface from which light by the light source 2 is emitted. By means of this configuration, the distance between an optically distant end of the large-sized light guiding plate 3 and the light source 2 is reduced, so that the luminance at the optically distant end of the large-sized light guiding plate 3 can reach the level required for display and the luminance of the whole plate 3 can be more uniform.

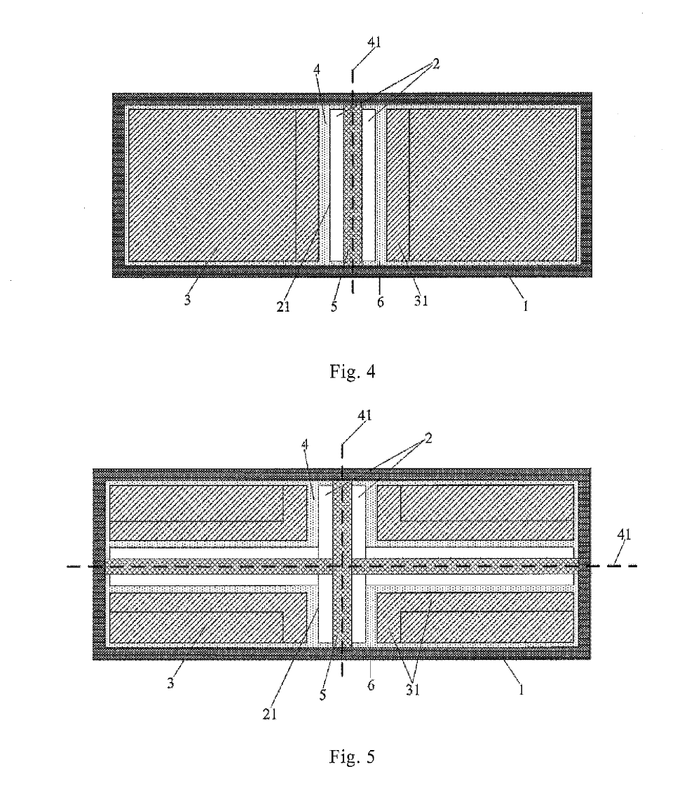

In the present embodiment, there are two light guiding plates 3. As illustrated in FIG. 4, the two light guiding plates 3 have the same size and shape. The two adjacent light guiding plates 3 are disposed symmetrically with the central line 41 of the spacing region therebetween as a symmetry axis. The light source 2 is disposed along the central line 41 of the spacing region 4 and has its light emitting surface 21 parallel to the central line 41. The central line 41 of the spacing region 4 refers to a line that divides the spacing region 4 into halves in a direction perpendicular to the direction in which the two light guiding plates 3 are arranged.

In an embodiment of the present disclosure, the backlight source comprises a plurality of light sources arranged continuously along the central line 41 of the spacing region 4.

As illustrated in FIG. 2, the light guiding plate 3 is disposed parallel to the back plate 1 with an angle formed between the first side 31 and the bottom surface 32 of the light guiding plate 3. The light emitting surface 21 of the light source 2 is parallel to the central line 41 of the spacing region 4, faces the first side 31, and forms, with respect to the back plate, an angle larger than that between the first side 31 and the back plate. The height of the light source 2 in the direction perpendicular to the back plate is less than the thickness of the light guiding plate 3. The light emitting surface 21 of the light source 2 is capable of emitting light with angles in a range of 60-120° with respect to the surface itself. By means of this configuration, it is ensured that most light rays emitted from the light emitting surface 21 of the light source 2 are radiated onto the first side 31. Because most light incident onto the first side 31 can penetrate into the light guiding plate 3 through the first side 31 and their travel directions can be changed and uniformly mixed by the light guiding plate 3 to satisfy the luminance required by the display panel for display, the utilization efficiency of the light from the backlight source is greatly improved by the configuration of the above-mentioned backlight source.

In the present embodiment, the angle between the first side 31 and the bottom surface 32 of the light guiding plate 3 is in a range of 30°-60°. The setting of the angle range makes the light incident onto the first side 31 partially reflected to a region of the display panel above the spacing region 4 by the first side 31, so that display luminance in the region of the display panel corresponding to the spacing region 4 is guaranteed and there is no significant difference in luminance between the regions of the display panel corresponding to the spacing region 4 and a region corresponding to the light guiding plate 3 so as to guarantee the uniformity of display luminance of the whole display panel.

In the present embodiment, the backlight source further comprises a heat sinking plate 5 disposed on the back plate along the central line 41 of the spacing region 4. Two opposite plate surfaces of the heat sinking plate 5 are perpendicular to the back plate respectively. A light source 2 is disposed on each of the two opposite plate surfaces respectively. The heat sinking plate 5 is made of aluminum with its one end fixed on the back plate 1 by screws or pins. Of course, the heat sinking plate 5 can also be made of any other good heat conductor. By means of employment of the heat sinking plate 5, heat generated when the light source 2 is illuminating can be conducted away in time. Since the heat sinking plate is connected to the back plate 1 by means of screws or pins, the heat can be further conducted outside of the backlight source to protect the backlight source and the display panel from failures due to high internal temperatures. The height of the heat sinking plate 5 in the direction perpendicular to the back plate 1 is less than or equal to the thickness of the light guiding plate 3. This enables to keep the upside of the light guiding plate 3 flat, so that the display panel disposed above the backlight source is not liable to be assembled slantly.

It should be noted that the plate surfaces of the heat sinking plate 5 onto which the light source 2 is disposed can also be configured parallel to the first side 31 of the light guiding plate 3, i.e. the longitudinal section of the heat sinking plate 5 along a line perpendicular to the central line 4 of the spacing region 4 has a shape of inverse trapezoid to ensure that there is no significant difference in luminance between the regions of the display panel corresponding to the spacing region 4 and the light guiding plate 3 and thus to guarantee uniformity of the display luminance all over the whole display panel.

In the present embodiment, the bottom surface 32 of the light guiding plate 3 has mesh points disposed thereon, which are generally mesh-point patterns arranged regularly and enable the light incident thereon to be reflected toward the top surface 33 of the light guiding plate 3 and then emitted uniformly outside from the top surface 33. By means of the mesh points disposed on the bottom surface 32 of the light guiding plate 3, the total reflection of light by the bottom surface 32 can be frustrated to make the light incident onto the bottom surface 32 reflected toward upside of the bottom surface and then emitted through the top surface 33 with an uniform luminance, which facilitates to provide a display luminance required by the display panel.

In the present embodiment, the backlight source further comprises a reflection sheet 6, which is disposed between the back plate 1 and the light guiding plate 3 and extends into a region corresponding to the light source 2. The reflection sheet enables light incident between the back plate 1 and the light guiding plate 3 as well as between the back plate 1 and the light source 2 to be reflected toward upside of the backlight source so as to increase the utilization efficiency of light of the backlight source.

In the present embodiment, as illustrated in FIG. 3, the backlight source further comprises prism sheets 7, 8 and a diffusing sheet 9 disposed above the light guiding plate 3, the prism sheets comprise a lower prism sheet 7 and an upper prism sheet 8 and being configured to collecting axial light and the diffusing sheet 9 being configured to diffuse light to increase the utilization efficiency of light of the backlight source.

### Embodiment Two

The present embodiment provides a backlight source which is different from that in embodiment 1 in that it has four light guiding plates 3 as illustrated in FIG. 5. The four light guiding plates 3 have the same size and shape and any two adjacent ones of them are disposed symmetrically with the central line 41 of the spacing region 4 therebetween as the symmetry axis.

In the present embodiment, the backlight source is the same as the one in embodiment one in terms of structures and materials, which will not be described repeatedly here.

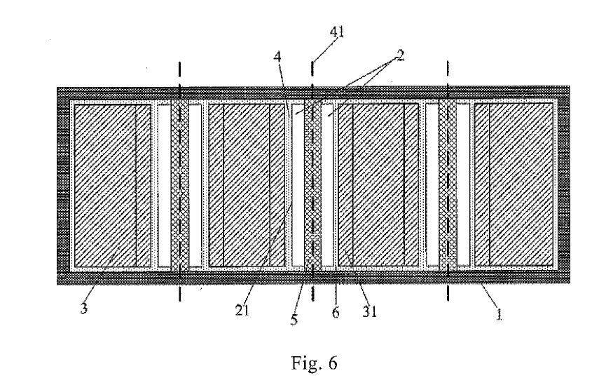

It should be noted that, the above-mentioned four light guiding plates 3 can also be configured as illustrated in FIG. 6, wherein a side of the light guiding plate 3 that are adjacent to a side surface of the back plate 1 can be inclined at an angle as the first side 31 or be perpendicular to the bottom surface of the back plate 1, as long as the first side 31 of the light guiding plate 3 facing the spacing region 4 is an inclined surface (e.g. an angle of 30°-60° inclined between the first side 31 and the bottom surface). Additionally, the amount of the light guiding plates 3 can be larger than 2, which is dependent on the size of the display panel. The larger the display panel is, the greater the amount of the light guiding plates 3 is, while the smaller the display panel is, the less the amount of the light guiding plates 3 is, as long as uniformity of display luminance of the whole display panel can be guaranteed.

Beneficial Effects

In the backlight source provided in the above embodiments, there are at least two light guiding plates disposed, among any two adjacent ones of which there has a spacing region therebetween in which a light source is disposed, so that the display luminance of the big-size display panel can be more uniform and the luminance of the optically distant end of the big-size light guiding plate can reach a level required for display. Moreover, the backlight sources are all side illustrating ones, which, compared with the direct illuminating ones, have an overall thickness that is greatly reduced, are lighter and thinner, and have a much lower quantity of light sources, so that the power consumption of the backlight source is greatly saved.

### Embodiment 3

The present embodiment provides a display device comprising the backlight source as described in embodiment 1 or embodiment 2.

By means of the backlight source as described above, the display device has its luminance more uniform and thus its display effect can be greatly improved. Moreover, by means of the backlight source as described above, the display device is lighter and thinner and has lower power consumption.

The foregoing are merely exemplary embodiments of the invention, but are not used to limit the protection scope of the invention. The protection scope of the invention shall be defined by the attached claims.

The present application claims priority of China patent application No. 201410027288.1 filed on Jan. 21, 2014, the disclosure of which is hereby entirely incorporated by reference.

1. A backlight source, comprising a back plate, a light source and at least two light guiding plates, wherein the at least two light guiding plates are disposed in a same layer over the back plate and spaced from each other, the light source is disposed in a spacing region formed between two adjacent ones of the at least two light guiding plates, and a light emitting surface of the light source is disposed opposite to a first side of the light guiding plate facing the spacing region.

2. The backlight source of claim 1, wherein the light guiding plate is disposed parallel to the back plate and the first side of the light guiding plate forms an angle with respect to the base surface of the light guiding plate; the light emitting surface of the light source is parallel to a central line of the spacing region, faces the first side, and forms an angle with respect to the back plate that is greater than the angle formed between the first side and the back plate, and a height of the light source in the direction perpendicular to the back plate is less than a thickness of the light guiding plate.

3. The backlight source of claim 1, wherein the at least two light guiding plates have a same size and shape and two adjacent ones of the at least two light guiding plates are disposed symmetrically with the central line of the spacing region therebetween as a symmetry axis; the light source is disposed on the central line of the spacing region and has its light emitting surface parallel to the central line of the spacing region.

4. The backlight source of any one of claims 1, wherein the light emitting surface of the light source is capable of emitting light within a range with an angle of 60°-120° with respect to the surface.

5. The backlight source of claim 1, wherein the angle between the first side and the base surface of the light guiding plate is within a range of 30°-60°.

6. The backlight source of claim 1, wherein the backlight source comprises a plurality of light sources arranged continuously along the central line of the spacing region.

7. The backlight source of claim 1, further comprising a heat sinking plate, which is disposed on the back plate along the central line of the spacing region and has its two opposite sides facing the light guiding plates, each of the sides provided with the light source.

8. The backlight source of claim 7, wherein a height of the heat sinking plate in the direction perpendicular to the back plate is less than or equal to a thickness of the light guiding plate.

9. The backlight source of claim 8, wherein the heat sinking plate is made of good heat conductors and fixed on the back plate.

10. The backlight source of claim 9, wherein the heat sinking plate is fixed on the back plate by means of screws or pins.

11. The backlight source of claim 1, wherein the base surface of the light guiding plate has mesh points disposed thereon, which enable the light radiated thereon to be reflected toward the top surface of the light guiding plate and then emitted uniformly from the top surface.

12. The backlight source of claim 1, wherein the backlight source further comprises a reflection sheet, which is disposed between the back plate and the light guiding plate and extends into a region under the light source.

13. The backlight source of claim 1, wherein the backlight source further comprises a prism sheet and a diffusing sheet which are disposed over the light guiding plate, with the prism sheet being configured to collect axial light and the diffusing sheet being configured to diffuse light.

14. A display device comprising the backlight source of claim 1.

15. The backlight source of claim 2, wherein the at least two light guiding plates have a same size and shape and two adjacent ones of the at least two light guiding plates are disposed symmetrically with the central line of the spacing region therebetween as a symmetry axis; the light source is disposed on the central line of the spacing region and has its light emitting surface parallel to the central line of the spacing region.

16. The backlight source of claim 2, wherein the light emitting surface of the light source is capable of emitting light within a range with an angle of 60°-120° with respect to the surface.

17. The backlight source of claim 3, wherein the light emitting surface of the light source is capable of emitting light within a range with an angle of 60°-120° with respect to the surface.

18. The backlight source of claim 2, wherein the angle between the first side and the base surface of the light guiding plate is within a range of 30°-60°.

19. The backlight source of claim 3, wherein the angle between the first side and the base surface of the light guiding plate is within a range of 30°-60°.

20. The backlight source of claim 4, wherein the angle between the first side and the base surface of the light guiding plate is within a range of 30°-60°.
